(19) United States
(12) Patent Application Publication
(10) Pub. No.: US 2013/0057176 A1
(43) Pub. Date: Mar. 7, 2013

(54) Discharge Device Driving Method

(71) Applicant: Robert G. Marcotte, New Paltz, NY (US)

(72) Inventor: Robert G. Marcotte, New Paltz, NY (US)

(21) Appl. No.: 13/218,742

(22) Filed: Aug. 26, 2011

Related U.S. Application Data
(60) Provisional application No. 61/402,332, filed on Aug. 27, 2010.

(51) Int. Cl. H05B 41/30

(52) U.S. Cl. 315/252; 315/287

(57) ABSTRACT

Disclosed are circuits and methods for driving discharge devices wherein during illumination, a first electrode is driven with pulses that maintain ON state wall charges, while a reference electrode is held at a constant voltage. With these circuits and methods, one or more reference electrodes are held to a reference voltage, such as ground, while one or more electrodes initiate two discharges necessary to maintain a wall charge. Additionally, the invention discloses driving methods that reduce electrode inductance while maintaining the separation of a driving side and a reference side. Embodiments divide the plurality of driving electrodes into two or more groups of electrodes and utilize a resonant driver to transfer charge between the groups of electrodes. The electrode inductance is dramatically reduced because adjacent electrodes, rows of electrodes or groups of rows, have substantially equal but opposite current flows.

### CROSS-REFERENCES

This application claims the priority of provisional application: 61/402,332 filed on Aug. 27, 2010 by inventor Robert G Marcotte entitled: “Single Sustainer Driving Method for a Plasma Display”

### BACKGROUND OF THE INVENTION

1. Field of the Invention

The present invention relates to the operation of gas discharge devices used for illumination and information display, including flat panel lamps, plasma display panels and TVs. More particularly, the invention provides electronic circuits and operating methods for improving operational characteristics while reducing cost and complexity.

2. Description of the Related Art

Gas discharge devices comprise a dischargeable gas disposed between, or adjacently, to a pair of driving electrodes. Prior to a discharging condition, dischargeable gases have the characteristic of being non-conductive, and therefore capacitive. Upon exceeding a breakdown voltage characteristic, the dischargeable gas becomes conductive and forms a plasma. As current flows through the plasma discharge, molecular and atomic excitation yields the emission of visible and/or ultraviolet light photons. Adjacent to the plasma discharge, a phosphor material may convert ultraviolet photons to visible light. Coating the electrode with a layer of a secondary emissive material comprising at least one of; MgO, CaO, BaO, SrO or other suitable material aids in the gas discharge formation.

Two or more driving electrodes may be fabricated on flat, curved, or flexible substrates. Alternatively, the driving electrodes may extend outward and into the dischargeable gas volume as in a fluorescent lamp. Pluralities of driving electrodes enable segmentation of the device into illumination areas. An array of driving electrodes, arranged in parallel, segments the illumination area into vertical or horizontal strips. An array of driving electrodes, arranged perpendicularly, forms a matrix of rows and columns. Electrode crossing areas form discharge cells. Matrix devices may be addressable through specific selection of row and column intersections.

A dielectric barrier gas discharge device has a dielectric material, such as a glass composition, covering one or both driving electrodes. The surface of the driving electrode's dielectric barrier holds a wall charge, defining an ON or OFF state. The dielectric strength of the dielectric material allows wall charges to remain on the dielectric surface virtually indefinitely. Hence, these devices are said to have memory. As charge is added to, or removed from, the barrier surface, a wall voltage across the dielectric barrier is increased or decreased.

The generation of plasma discharges, within an illumination area corresponding to a pair of sustain electrodes, is dependent upon the initial wall charge on the dielectric surfaces of the first and second sustain electrodes. A plasma discharge occurs within a discharge cell if the dielectric surface holds a ‘set’ wall charge. The set wall charge, and particularly it's corresponding wall voltage, is additive to voltages applied to the sustain electrodes. When the combined applied voltage is in excess of the dischargeable gas breakdown voltage, a plasma discharge is induced within the illumination area.

The dielectric barrier limits the gas discharge to a momentary occurrence. Current flow, through the plasma, reduces the voltage across the dischargeable gas to zero as charge accumulates on each sustain electrode's dielectric surface. Each plasma discharge produces a burst of ultra violet (UV) photons which excite phosphor materials in the vicinity of the plasma which, in-turn, emit visible light. Since each plasma discharge produces only a fraction of the desired output illumination, a large number of plasma discharges is required for adequate illumination.

In a prior art driving method illustrated in FIG. 1, a pair of sustain circuits produce output waveforms SA and SB to drive respective sustain electrodes of an illumination area. Applying a first sustain waveform SA to the first sustain electrode and a second sustain waveform SB to the second sustain electrode of an illumination area, yields a voltage VP affectively applied to the illumination area. Current Ip illustrates the current flow through the capacitively coupled sustain electrodes. Each rising and falling voltage transition of waveforms SA and SB produce respective transition current pulses IT. The current flow through the dischargeable gas, drawn by each plasma discharge, is illustrated by current pulses IGA and IGB. That is, the wall charge within the illumination area is maintained by having a set wall charge within the illumination area, applying a first sustain pulse SA to induce a first sustain discharge current IGA and applying a second sustain pulse SB to induce a second sustain discharge current IGB. Thus each sustain cycle requires two sustain pulses driven from two sustain circuits.

The prior art has the problem of duplicity sustain driver circuits. As can be seen from FIG. 4, for each alternating sustain pulse pair, sustain pulses SA and SB are interdigitated. Each sustain circuit drives rising and falling resonant transitions producing current pulses IT, and each sustain circuit sources a gas discharge immediately following each rising transition following the closure of respective switches S3 at times t3 and t6. Each gas discharge produces a gas discharge current Iga and Igb. Thus each sustain circuit applies only one of the two gas discharge currents necessary to maintain the wall charge at each discharge location.

Interdigitated sustain pulses have a problem in that they require fast rise and fall times to prevent pixels from self-extinguishing, thus increasing power consumption. As shown by signal Vp, the transition time t4-t7 for output SA to fall and for output SB to rise to initiate gas discharge IGB is long and the transition as shown by waveform Vp is discontinuous. Gas discharge IGB can begin forming anytime between times t5 and t7, thus weakening or eliminating the gas discharge at time t7. To minimize the likelihood of premature discharging between time t5 and t7, the rise and fall times, t1-t3, t4-t5, t6-t7 need to be short, thus making fast transitions. With the large capacitive load of large area discharge devices, fast transitions result in exceedingly large transition currents IT.

Fast transition times equate to high frequency switching currents. As each transition current's resonant frequency increases, resistive losses increase due to AC resistance, i.e. skin effects. Referring to the application of pulse SA, the rising transition time t1-t3 is controlled by the resonant frequency of an inductor and the interelectrode capacitance. Each transition produces current pulse IT, during this same time period. As this current is half of a sign wave near to, or greater, than 1 Mhz, resistive losses by the currents amplitude, duration and repetition frequency produce significant losses within the driving circuitry. Similarly, the rate of change on the currents is high, meaning that they have a large di/dt which induces inductive voltage drops along the current path including the system wide grounding plane.

In a large area discharge device, long electrodes have additional resistive and inductive characteristics. Larger electrode inductances present a problem in that under the prior art driving conditions, the long, magnetically coupled driving electrodes demonstrate a large inductance under unidirectional current flow. A unidirectional current flow occurs when parallel electrodes are driven concurrently and the majority of the current flow is from the driving side, on a first axis of the device, to the return side along a second axis of the device. As the applied voltage, plus the wall voltage, reaches the discharge point, the gas discharge initiates, the voltage across the gas drops sharply and current flow is impeded by the driving electrode's inductance. As the voltage droops, the discharge is impeded. The current increases to supply the discharge current, however the efficacy of the gas discharge is reduced and the brightness across the gas discharge device's illumination area becomes less uniform.

An AC plasma display panel (henceforth referred to as a PDP) is a dielectric barrier gas discharge device wherein the panel's illumination area is divided into a matrix of discharge cells, i.e. pixels. Individually selectable scan and data electrodes support addressing the matrix of discharge cells by applying data pulses, processed to correspond to a display image while sequentially selecting (i.e. scanning) each row of discharge cells.

In an PDP, the scan side circuitry comprises a plurality of circuits, disposed in series, to provide sustain pulses, initialization and row scanning functionality. Thus the scan side circuitry is highly complex due to the types of operations that the circuit must perform. Power and voltage losses are increased as the sustain pulse transition currents and plasma discharge currents that must flow through the series circuits.

Thus, there is a need for reducing the number of circuits, reducing circuit complexity and cost, increasing the transition time to lower the frequency and peak current of transition currents, prevent erroneous discharges and reduce electrode inductance.

The invention further seeks to improve brightness and efficiency for PDPs operated under heavy discharge loads while reducing power consumption, manufacturing cost, and electromagnetic interference.

### SUMMARY OF THE INVENTION

The invention contained herein provides circuits and operating methods that address the aforementioned problems. Devices that may include the invention comprise gas discharge devices and in particular multi-electrode dielectric barrier discharge devices used for illumination and addressable matrix gas discharge devices, such as PDPs.

First exemplary embodiments of the invention reduce the complexity of the driving electronics by replacing the return, or scan, side sustain pulse generation circuit with a low cost initialization and bias circuit and expanding the operating range of the sustain side driving electronics to approximately twice that of the prior art. Thus, with the invention, the return, or scan, electrodes are primarily for initialization and addressing, and the sustain electrodes are for driving sustain pulses including initiating the gas discharges. This removes the duplicity of sustain circuits.

These embodiments provide circuits and methods for driving gas discharge devices wherein during illumination, a first electrode of an illumination area is driven with sustain pulses that maintain ON state wall charges, while a second electrode is held at a constant voltage. With these circuits and methods, one or more reference electrodes are held to a reference voltage, such as ground, while one or more sustain electrodes initiate two gas discharges necessary to maintain a wall charge.

Second exemplary embodiments of the invention reduces the electrode inductance while maintaining the first embodiment's separation of a sustain pulse driving side and an initialization and bias return side. These embodiments divide the plurality of sustain electrodes into two or more groups of electrodes and utilize a resonant sustain driver to transfer charge between the groups of electrodes. With these embodiments, one group of sustain electrodes is driven with a rising resonant transition voltage waveform, while the second group of sustain electrodes is concurrently driven with a falling resonant transition voltage waveform. The electrode inductance is dramatically reduced because adjacent electrodes, rows of electrodes or groups of rows, have substantially equal but opposite current flows. The lowered inductance, enables higher and faster discharge currents that exhibit increased brightness and efficacy. Power consumption is reduced as the transition current flows are cut in half by the division of the plurality of electrodes into two groups.

These second embodiments also constrain a large portion of the pulsed currents to within the discharge device. With the sustain driving circuit applying both rising and falling currents, the capacitively coupled return side sinks currents from one half of the return side electrodes while concurrently sourcing currents to the second half of the of the return side electrodes. Thus the majority of the currents are constrained to the driving side electronics and the illumination panel. Electromagnetic interference is also reduced as the chassis currents are reduced. In some applications, the large metallic chassis may be reduced to smaller conductive or non-conductive components.

### BRIEF DESCRIPTION OF THE DRAWINGS

FIG. 1 illustrates a prior art sustain pulse driving waveform with interdigitated sustain pulses.

FIG. 2 illustrates a variety of discharge cell structural elements.

FIG. 3 illustrates segments of a driving waveform for describing elements of the invention.

FIG. 4 illustrates a block diagram for surface discharge PDP embodiment of the invention.

FIG. 5 illustrates a driving waveform for the PDP of FIG. 4.

FIG. 6 illustrates a driving circuit for the waveform of FIG. 5.

FIG. 7 illustrates a waveform for driving an opposed discharge embodiment of the invention.

FIG. 8 illustrates a block diagram for a PDP embodiment of a two phase sustain pulse generator wherein currents are constrained to be within a PDP embodiment.

FIG. 9 illustrates a driving waveform for the PDP of FIG. 8.

FIG. 10 illustrates a driving circuit for the waveform of FIG. 9.

FIG. 11 illustrates a sustain pulse detailed waveform for the PDP of FIG. 8.

FIG. 12 illustrates a first top view of a first electrode configuration for the PDP of FIG. 8.

FIG. 13 illustrates a second top view of a second electrode configuration for the PDP of FIG. 8.

FIG. 14 illustrates a top view of an electrode configuration for an ALiS type PDP.

### DESCRIPTION OF THE INVENTION

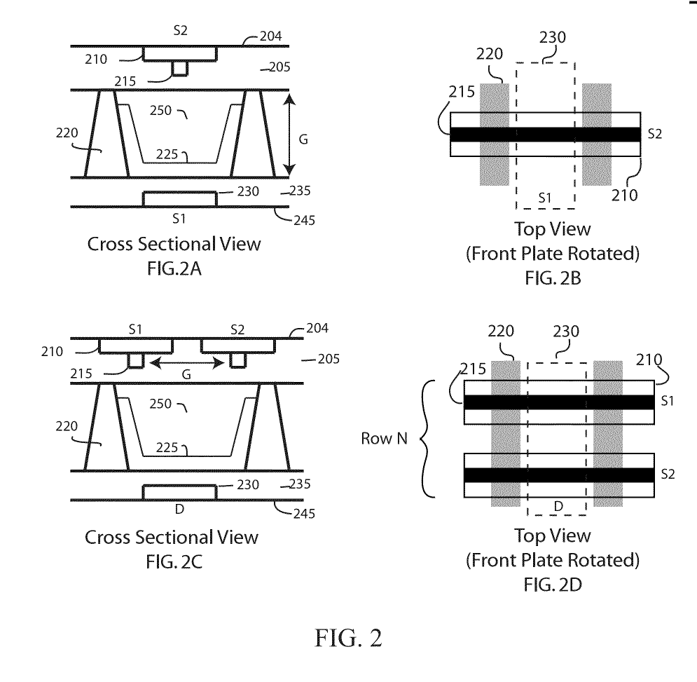

FIG. 2 provides embodiments of discharge cell structures for several dielectric barrier discharge device electrode configurations. Large illumination areas may be formed by arraying the embodiments of FIGS. 2A-2D into pluralities of rows or columns, or into a matrix of discharge cells. Pluralities of electrodes may be oriented in parallel as in a simple illumination device having a plurality of long discharge cells, or may be oriented orthogonally to form an addressable illumination device (a PDP) having a matrix of discharge cells adjacent to electrode crossing areas.

FIG. 2A provides a cross-sectional view of an opposed discharge device wherein two electrode structures, S1 and S2 are disposed in parallel but on opposing substrates. Specifically, a back substrate 245 supports a first electrode S1 covered by a first dielectric layer 235. Barrier ribs 220 provide substrate separation and a surface whereon a phosphor coating 225 is deposited. The barrier ribs 220 form a channel 250 containing a dischargeable gas. A front substrate 204 supports a second electrode structure S2 comprising a transparent electrode portion 210 and a more conductive bus electrode portion 215. Electrode structure S2 is covered by a second dielectric layer 205. During sustain periods, sustain discharges will be induced across the discharge gap G, and the sustain discharges will extend the length of the channel formed by the barrier ribs 220.

FIG. 2B provides a top view of the structure of FIG. 2A wherein the front substrate is rotated 90 degrees to form an opposed discharge cell at the electrode crossing area.

FIG. 2C has like features as FIGS. 2A and 2B, applied to a surface discharge electrode configuration, wherein the plasma discharge gap G is the separation between the parallel and adjacent front electrodes S1 and S2. With this configuration, the back electrode may be driven selectively, or may be coupled to a reference potential for a non-addressable illumination device.

FIG. 2D provides a top view of the structure of FIG. 2C wherein the front substrate is rotated 90 degrees to form a surface discharge cell at the electrode crossing area as is commonly applied to PDPs.

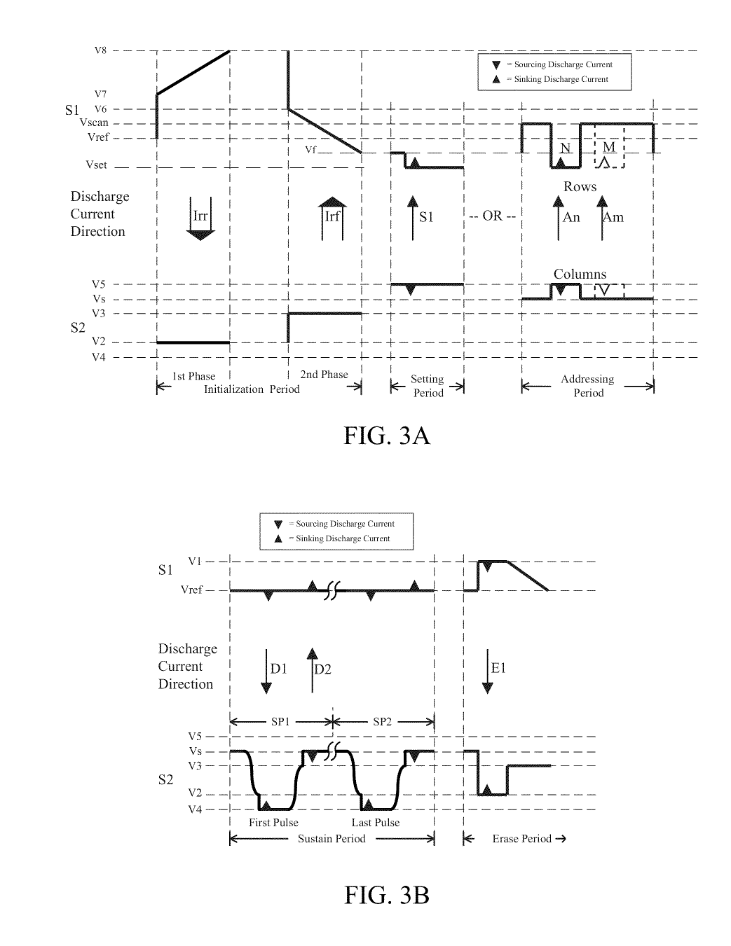

FIGS. 3A and 3B illustrate a breakdown of the voltage application steps of the invention for a series of time periods. As shown in FIG. 2, the invention may be applied to a variety of structural configurations, each having specific voltage requirements. Also, the pluralities of electrodes are capacitively coupled. Thus, the magnitude and direction of voltage transitions between the sustain electrodes is of greater importance than DC levels shown in each element. The time periods described are; an initialization period having two phases, a setting period for setting a wall charge in a non addressable illumination device, an addressing period for setting a wall charge in an addressable matrix display, a sustain period to illuminate the device in discharge cells wherein wall charges have been provided, and an optional erase period for removing the set wall charge.

The initialization period provides a global wall charge initialization and reset for the illumination device. Referring to the figure, during a first phase of the initialization period, a potential V2 is applied to the sustain electrode S2, and a rising initialization voltage V8 is applied over time to the setting electrode S1 from a voltage V7 to a voltage V8. The starting point voltages, i.e. V2 and V7 are selected to apply a combined voltage across the dischargeable gas close to, but below, the dischargeable gas's breakdown voltage. As the rising initialization voltage increases, the voltage across the dischargeable gas slowly approaches, reaches and exceeds the breakdown voltage of the dischargeable gas in a first polarity. Weak initialization discharges create a small initialization discharge currents Irr flowing from the setting electrode to the sustain electrode, adjusting the wall charge on the each electrode's dielectric barrier surface.

During a second phase of the initialization period, a potential V3 is applied to the sustain electrode, and a falling initialization voltage Vf is applied to the setting electrode over time. The starting point voltages, i.e. V3 and V6 are selected to apply a combined voltage across the dischargeable gas close to but below the dischargeable gas's breakdown voltage in a second polarity. As the falling initialization voltage decreases, the voltage across the dischargeable gas slowly approaches, reaches and exceeds the breakdown voltage of the dischargeable gas. Weak initialization discharges create a small initialization discharge current Ifr flowing from the sustain electrode to the setting electrode, adjusting the wall charges on the each electrode's dielectric barrier surface.

Upon completion of the initialization period, the weak initialization discharges leave a voltage, across the dischargeable gas adjacent to the discharge cell that is approximately equal to the breakdown voltage of the dischargeable gas. This interelectrode voltage setting allows for the inducement of a setting discharge with the application a small setting pulse voltage.

Subsequently, during the setting period, a setting reference potential V5 is applied to the sustain electrode S2. A setting pulse is applied to the setting electrode 51 wherein the applied voltage steps down from the falling initialization voltage Vf to setting potential Vset. The falling setting pulse transition voltage (Vf minus Vset) is additive to the wall voltage established during the second phase of the initialization period wherein the decreasing falling initialization voltage ended the transition at the voltage Vf. In prior art methods for driving a PDP, it is common to apply a small setting pulse transition voltage (Vf minus Vset) to aid in matrix addressing. Applying larger voltages, sufficiently in excess of the dischargeable gas's breakdown voltage, is likewise known to induce a setting discharge. Thus a larger setting pulse is used to set an entire illumination area. The setting discharge creates a plasma, reducing the voltage across the dischargeable gas to zero while charging the capacitance of the dielectric barrier. Thus, upon completion of the setting period, the fully charged dielectric barrier walls are provided with a set wall charges indicative of an ON illumination state. Once the dielectric barrier surfaces have been charged, the plasma discharge self-extinguishes, thus storing the set wall charge.

Alternatively to the setting period, and addressing period may be utilized to address specific discharge cells within a matrix of discharge cells. To isolate rows for addressing, a voltage Vscan is applied to a plurality of electrodes S1 once the falling initialization voltage Vf has been applied. A scan pulse applies voltage Vset sequentially to rows of the matrix. Relative to the previously described setting pulse, the differential between Vset and Vf is small to prevent falsely setting discharge cells. Pluralities of data pulses are applied to plural columns of the matrix to selectively set the wall charge in specific discharge cells according to display data representative of an image to be illuminated during the following sustain period.

A sustain period maintains the set wall charge while producing illumination. With the invention, a reference potential Vref is applied to the setting electrode S1, and a first sustain pulse SP1 is applied to the sustain electrode S2. The reference potential Vref is selected relative to the setting voltage Vset so that the leading edge application the first sustain pulse voltage V4, when added to the set wall charge, is sufficient to induce a first sustain discharge D1. Upon completion of the first sustain discharge, the wall charge is substantially maintained while having a reversed polarity. Subsequently, on the trailing resonant transition, i.e. rising, of sustain pulse SP1, the breakdown voltage of the dischargeable gas is exceeded a second time, and thus a second sustain discharge is induced, again reversing the wall charge polarity back to the set wall charge polarity. Thus two resonant transitions of a sustain pulse maintains the wall charge. Thus a single sustain pulse SP1 comprises a first transition to induce a first discharge and a second transition to induce a second discharge.

As a reference, if the setting pulse had not been applied to induce the setting discharge during the setting period prior to the sustain period, there would not be sufficient wall voltage to induce the first sustain discharge. Thus a set wall charge must be provided for illumination.

An erase provides a method for removing the set wall charge. For an addressed matrix, and optionally for an illumination device, the set wall charge may be removed, i.e. returned to the unset or OFF state, through repeating the initialization period sequence, or by executing an erase method. Thus, during an erase period, a first erase discharge adjusts the set wall charges to levels approximately equal to those existing at the beginning of the second phase of the initialization period. The first erase discharge E1 is induced by applying a first voltage to the setting electrode V1, and a voltage V2 to the sustain electrode such that the breakdown voltage of the dischargeable gas is exceeded sufficiently to induce the first erase discharge. Voltages V1 and V2 may be chosen to minimize the strength of the first erase discharge E1 while assuring that the first erase discharge is induced throughout the entire illumination area. Upon completion of the first erase discharge E1, the second phase initialization method may be used to adjust the wall charges in preparation for another addressing or setting period. Once set wall charges are removed, the illumination area will not be illuminated unless an addressing or setting pulse is re-applied.

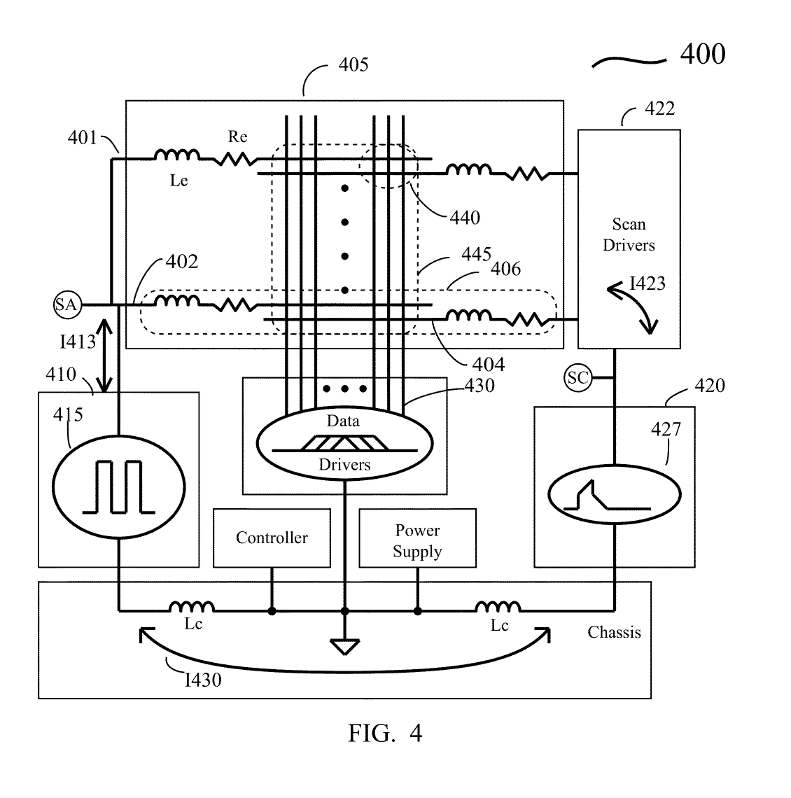

FIG. 4 illustrates a first exemplary embodiment of the invention for a surface discharge device 400. Illumination device 400 comprises a gas discharge panel 405 having an illumination area 445. A matrix of discharge cells 440 has pluralities of row electrode structures 406 and a plurality of data electrodes 430. To facilitate driving the discharge cells, pluralities of row electrode structures 406 comprises a pluralities of sustain electrodes 401-402 and corresponding pluralities of scan electrodes 403-404. Sustain and scan electrodes 401-402 and 403-404, respectively, exhibit mutually coupled inductances Le and resistances Re. Pluralities of sustain electrodes 401-402 are driven from sustain driver circuit 410 having an output SA. Sustain driver circuit 410 comprises a resonant sustain pulse driver 415 operable at a voltage relatively twice that of the prior art. Sustain pulse driver 410, is coupled through a conductive chassis to an initialization and wall charge setting circuit 427 having an output SC coupleable through scan drivers 422 to scan electrodes 402-404. Illumination device 400 further comprises orthogonally disposed data electrodes 430 fabricated on the back substrate, between barrier rib structures and under the phosphor materials. Thus the electrode crossing areas adjacent to the pluralities of row electrode structures and data electrodes define discharge cells. A color pixel 440 comprises three discharge cells for red, green and blue color selection. Alternatively, white phosphors may be employed. Thus a row illumination area is segmented into discharge cells each capable of holding wall charges. Each discharge cell is driven by a sustain electrode 401, a row electrode 403 and a data electrode 430. Row electrodes 403-404 are individually selectable by scan drivers 422. Scan drivers 435 are totem pole driver circuits floating on the output SC of the initialization and wall charge setting circuit 427 (henceforth referred to as the scan bias circuit).

Data drivers supply discharge cell selection pulses during addressing periods wherein data signals are provided to the data drivers according to display data received by the controller. Rows are selected by scan drivers 422 and a plasma discharge is induced in selected discharge cells to set wall charges according to display data.

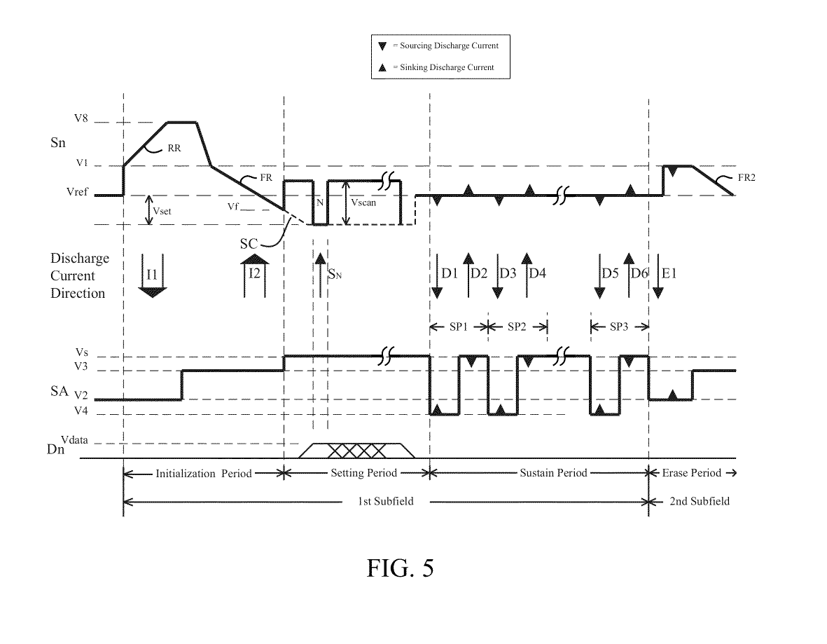

Operation of illumination device 400 will be described in reference to FIG. 5 to illustrate an exemplary driving method the invention on an addressable matrix of discharge cells. Waveform Sn is sequentially applied to one of the plurality of row electrodes 402-404. Relative to other illumination rows, waveform SN is differentiated from other row waveforms in the timing of row select pulse N which is sequentially applied to each display row. Waveform SA is the output SA of sustain driver 410 and commonly applied to all sustain electrodes concurrently. Waveform Dn is an exemplary output of a data driver for driving a data electrode 430. Data pulses Dn are activated according to display data respective to the row being selected. A controller provides timing control signals to the driving circuitry that outputs the aforementioned waveforms.

On each waveform, triangles indicate whether a plurality of sustain electrodes 401-402 and a plurality of scan electrodes 403-404 are sourcing or sinking current. A downward pointing triangle indicates the electrodes are sourcing current and an upward pointing triangle indicates the electrodes are sinking current. Similarly, the discharge current direction is displayed.

Referring to the time scale, a first subfield of a plurality of subfields constituting a video frame time is divided into an initialization period, an addressing period and a sustain period. The beginning of a second subfield displays the initial part of an erase period. It should be understood that erase period completes in like fashion to the initialization period shown in the first subfield and would be followed by repeated addressing, sustain and erase periods.

The first phase of the initialization period sets wall charges in all discharge cells of the display by applying a voltage V8 over time to the plurality of scan electrodes SC while a reference voltage V4 is applied to the sustain electrodes SA. Over the time ramp RR progresses in the positive direction, a series of weak or fluid-like discharges induce current Irr while establishing an initial wall charge on the dielectric and phosphor surfaces of each discharge cell. This is, as voltage V8 is applied over time with a rising characteristic, the gas breakdown voltage is slowly and/or repetitively exceeded creating weak discharges wherein small currents flow between the sustain, row and data electrodes such that the voltage across the dischargeable gas is maintained across all three surfaces.

In a second phase of the initialization period, a portion of the wall charge provided by the positive going ramp RR is removed by applying a voltage Vset over time to the plurality of scan electrodes SC while a voltage V3 is applied to the sustain electrodes SA. Over the time ramp FR progresses in the falling direction, a second series of weak or fluid-like discharges induce current Ifr. At the completion of the falling ramp, the remaining wall charges are such that the voltage across the gas in the vicinity of the three electrodes is at the breakdown voltage of the gas, with the scan electrode being a cathode while the sustain and data electrodes are anodes. This is, as voltage Vset is applied over time with a falling characteristic, the gas breakdown voltage is slowly and/or repetitively exceeded creating weak discharges where small currents flow between the sustain, row and data electrodes such that the voltage across the dischargeable gas is maintained across all three surfaces.

To enhance matrix addressing, the initialization period is terminated when the falling ramp FR reaches voltage Vf. Voltage Vf is referenced to the final ramp voltage Vset. The falling ramp FR's weak discharge action is terminated by the scan drivers applying voltage Vscan to the plurality of scan electrodes 403-404. The output SC of scan bias circuit 427 continues to ramp down to voltage Vset during the start of the addressing time period. By terminating the falling ramp FR's weak discharge action, voltage Vf will be effectively applied across the dischargeable gas during each row selection pulse of the addressing period. With Voltage Vf at approximately 8-10V greater than the row selection voltage Vset, the addressing discharge formation time and the required data pulse voltage are decreased. Similarly, the voltage applied to the sustain electrodes during the addressing period may set to a voltage greater than during the initialization period. Referring to the figure, the sustain electrodes have voltage Vs applied, which is greater than the voltage V3 used during initialization.

Wall charges for the full illumination of illumination device 400 may be set by applying a voltage Vf of 20-75V to the plurality of row electrodes 403-404. Alternatively, a pulse of similar voltage could be applied to the data electrodes to induce a setting discharge. Thus an illumination device of similar construction to a PDP may be illuminated with this setting method. Using this method, scan drivers 422 and data drivers 432 are not required and row electrodes may be driven in common by output SC of scan bias circuit SC.

The use of a negative voltage Vset relative the sustain pulse reference voltage Vref allows for the use of a single initialization period per video frame time. This differential ensures that wall charges disposed during initialization are undisturbed during subfields wherein the respective discharge cells are not set, i.e. OFF. There is also a relationship between the voltage Vset and voltage V3 applied during the second phase of the initialization or erase period, where lowering voltage Vset requires lowering voltage V3 during initialization or erase periods. Thus voltage V3 may be less than, equal to or greater than voltage Vs depending upon the final ramp voltage Vset and device construction.

The addressing period completes after sequentially applying scan and data pulses to each display row to individually set desired subpixels for illumination. Subsequently, the voltages Vscan and Vset are withdrawn to the reference voltage Vref. Typically voltages Vref and voltage V4 are zero volts, i.e. ground.

During the sustain period, the reference potential Vref, is applied to the scan electrodes while sustain pulses SP1-SP3 are applied to the sustain electrodes. A first sustain discharge D1 occurs in all discharge cells provided with a set wall charge during the addressing period. The combination of an ON state wall charge at specific pixels, the application of a voltage Vref, and the first transition of sustain pulse SP1 from voltage Vs to V4 creates a gas discharge D1. The current for gas discharge D1 is from the scan electrodes sourcing current to the sustain electrodes sinking current. Once discharge D1 completes, the ON state wall charge polarity has been reversed. A second reversal of the ON state wall charge polarity is required to maintain the wall charge. Thus, the reference potential Vref is maintained on the scan electrodes, and the second transition of sustain pulse SP1 from voltage V4 to Vs induces discharge D2. The discharge D2 is sourced by the plurality of sustain electrodes 401-402 and sinked by the plurality of scan electrodes 403-404. At each subsequent transition of sustain pulses SP2-SP3, sustain discharges will occur.

In a surface discharge type PDP, the sustain voltage Vs is approximately twice that of the prior art; i.e. between 300V and 400V. It is preferred that voltages Vref and V4 be connected to the system ground so that sustain discharge currents flowing back to the sustain circuit have minimal losses. Although the voltage is substantially greater than the prior art, the single resonant transitions between Vs and V4 allow for longer resonant transition times. Thus, for a prior art transition time of less than 1 us for each of two pulses, the invention would allow for transition times of 2 us or more with a single transition. Consequently, the peak current may be approximately equal between the prior art and the invention.

Following the last sustain pulse SP3 of the sustain period, the erase period clears the set wall charge an reinitializes only the discharge cells that were being illuminated. Consequently, a second subfield begins with an erase period and specifically a first erase discharge E1. Voltage V1 is applied to the scan electrodes and voltage V2 is applied to the sustain electrodes such that following erase discharge E1, wall charges disposed upon the discharge cell surfaces, are properly charged prior to the falling erase/re-initialization ramp pulse FR2. Increasing V1 and decreasing V2 will have similar effects depending upon construction geometries, therefore the settings may be optimized for a given illumination device.

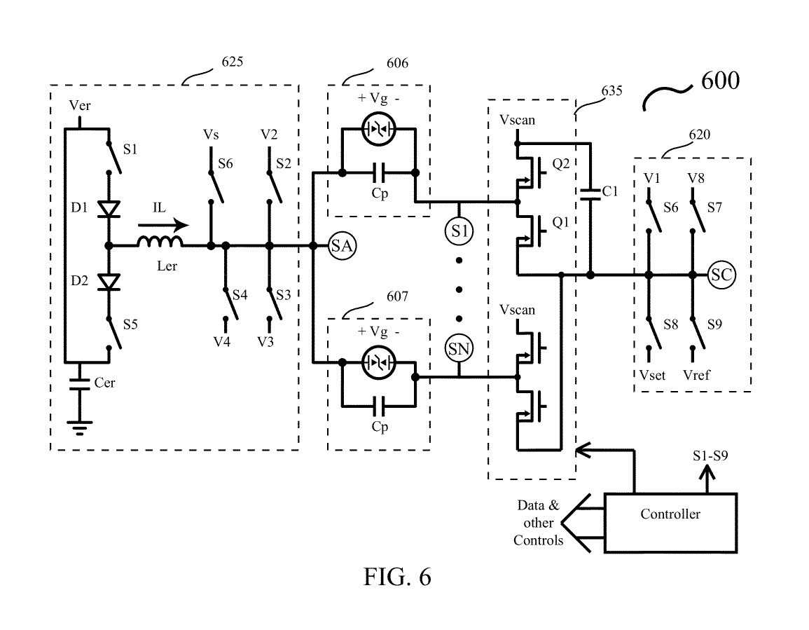

FIG. 6 provides a circuit diagram to generate the waveform of FIG. 5. Blocks 606 and 607 correspond to rows of pixels in the display. Sustain electrodes are driven by the output SA of a resonant sustain driver 625. The sustain circuit also comprises switches S2 and S3 to apply voltages V2 and V3, during erase and initialization periods respectively. It is preferred that all switches be transistors such as MOSFETs, IGBTs, or bipolar transistors. It is also preferred that switches S6 and S4 be implemented as a pluralities of transistors disposed along the PDP panel 405's sustain axis to facilitate sustain discharge current flow with a minimum of inductance.

Individual rows of discharge cells, i.e. illumination areas, 606 and 607 are connected to scan drivers 635 having totem pole outputs, wherein a lower transistor Q1 is ON during sustain periods and upper transistor Q2 is normally on during each addressing period. Transistor Q2 turns off and transistor Q1 turns on to select an row S1 for addressing. With switch S8 applying voltage Vset to output SC, and scan driver transistor Q1 ON, voltage Vset is applied to scan electrode S1, while the other scan electrodes including SN will have Vscan plus Vadd applied. The scan side driver, further comprises switches S6-S7 to apply the voltages V1 and V8 required for initialization and erase periods. That is, switch S6 provides voltage V1 during initialization and erase, S7 provides the rising ramp RR, switch S8 provides the falling ramp RF and the row select voltage Vset during the addressing period. Switch S9 connects all the scan electrodes to voltage Vref during the sustain period. It is preferred that voltage Vref be connected to the system ground, so as to eliminate the need for a power supply to produce a voltage Vref. It is also preferred that switch S9 be implemented as multiple transistors disposed along the PDP panel 405's scan axis to facilitate sustain discharge current flow with a minimum of inductance.

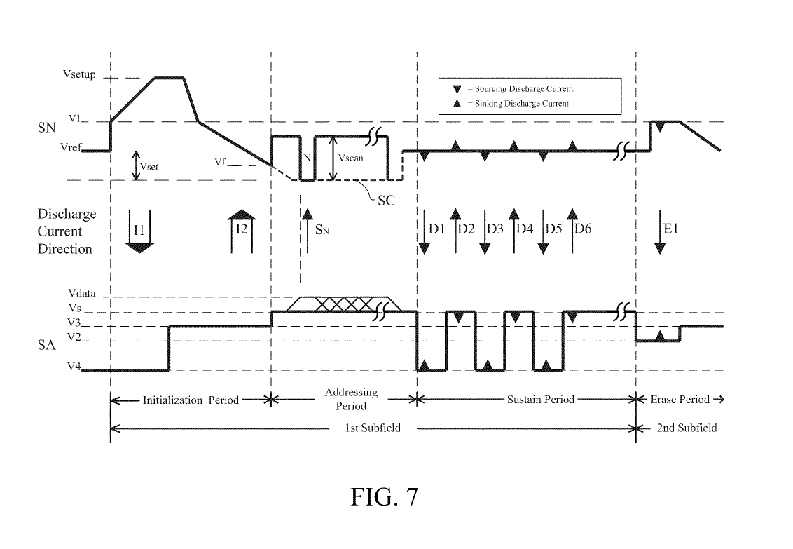

FIG. 7 provides a waveform that employs the first embodiment of the invention to an opposed discharge type plasma display having a matrix of discharge cells as shown in FIG. 2B. Having only two pluralities electrodes SA and SN, discharge cells are addressed in rows SN, and data pulses, applied during the addressing periods, are superimposed on the sustain waveform to drive data columns SA of the display. Initialization or erase periods initialize the wall charge across the discharge gap between scan and data electrodes, so that when a row is selected on a scan electrode, and a voltage Vdata is applied to the data electrode which is greater than the voltage V2 applied during the falling ramp of the setup or erase period, a gas discharge is fired to set the wall voltages of the selected pixel to the ON state. Once addressed, pixels maintain their wall charge into the sustain period. The scan electrodes are biased with a voltage Vref, and a negative going transition is applied to the data electrodes. In combination with the wall charge created during addressing, the voltage is sufficient to induce a first sustain discharge in pixels that received a wall voltage during the addressing period. Subsequently, applying a second, positive transition to the data electrodes utilizes the wall charges of the first sustain discharge to induce the second sustain discharge. Thus while the scan electrodes are biased with voltage Vref, alternating transitions on the data electrodes induce discharges with each transition.

As in the surface discharge embodiment, a final sustain discharge is induced by elevating the scan electrodes to a voltage V1 and transitioning data electrodes from the high level of Vs to an intermediate level V2 to shift the wall voltages so that the erase ramp can re-initialize the ON pixels in preparation for subsequent addressing.

Collectively, the first embodiment of invention provides the benefit of separating initialization and wall charge setting, or row addressing, functionality from the sustaining functionality. This embodiment reduces the complexity and power consumption on the scan side circuits by having a bias circuit apply a reference voltage during illumination periods. Thus, this embodiment comprises a single resonant sustain driver circuit applying a pulse comprising a first transition to a first voltage to induce a first discharge and subsequently applies a second transition to a second voltage to induce a second discharge. This embodiment further comprises a bias circuit for sourcing and sinking electrical currents induced by the resonant sustain driver circuit. The initialization and bias driver further comprises a first initialization circuit for inducing a first initialization discharge and a second initialization circuit for inducing a second initialization discharge. The second initialization circuit provides a setting voltage applied during wall charge setting periods.

In a second exemplary embodiment of the invention, a multi-phase sustain circuit transfers the capacitive energy of sustain pulses between first and second pluralities of sustain electrodes so that reciprocal currents flow through pairs or groups of rows to reduce electrode inductance and current flow through the chassis. As in the first embodiment, sustain pulses are applied to sustain electrodes while a reference voltage is applied to the return side electrodes.

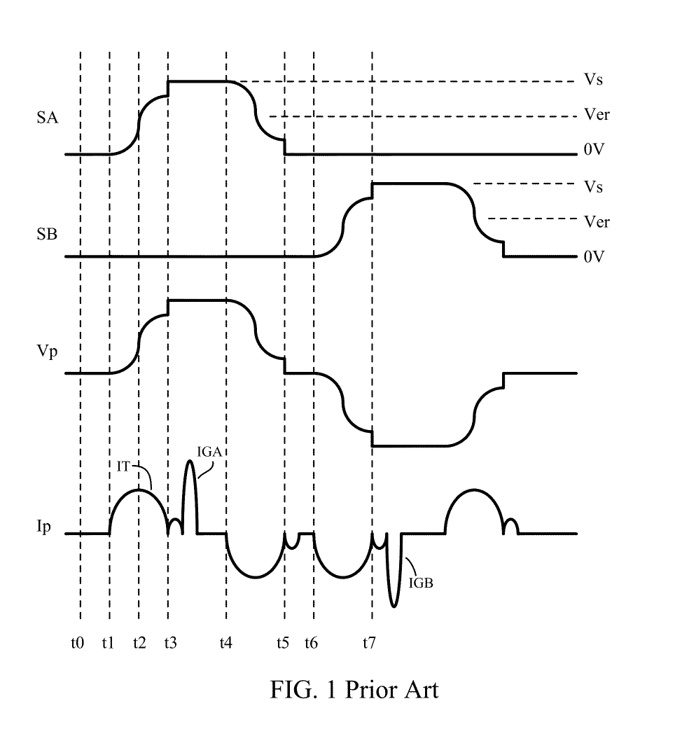

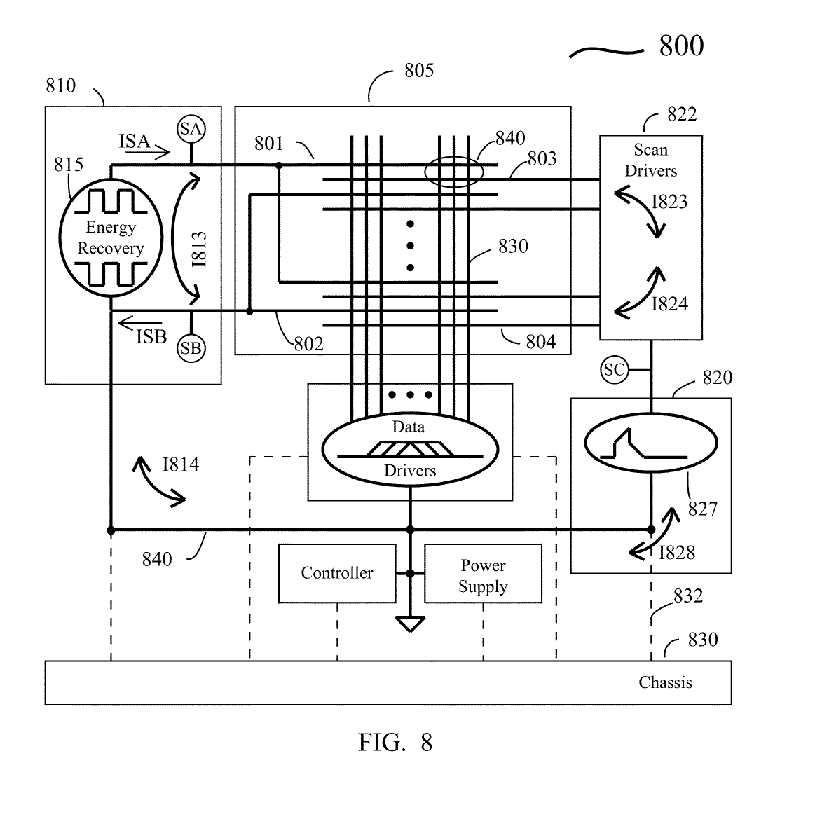

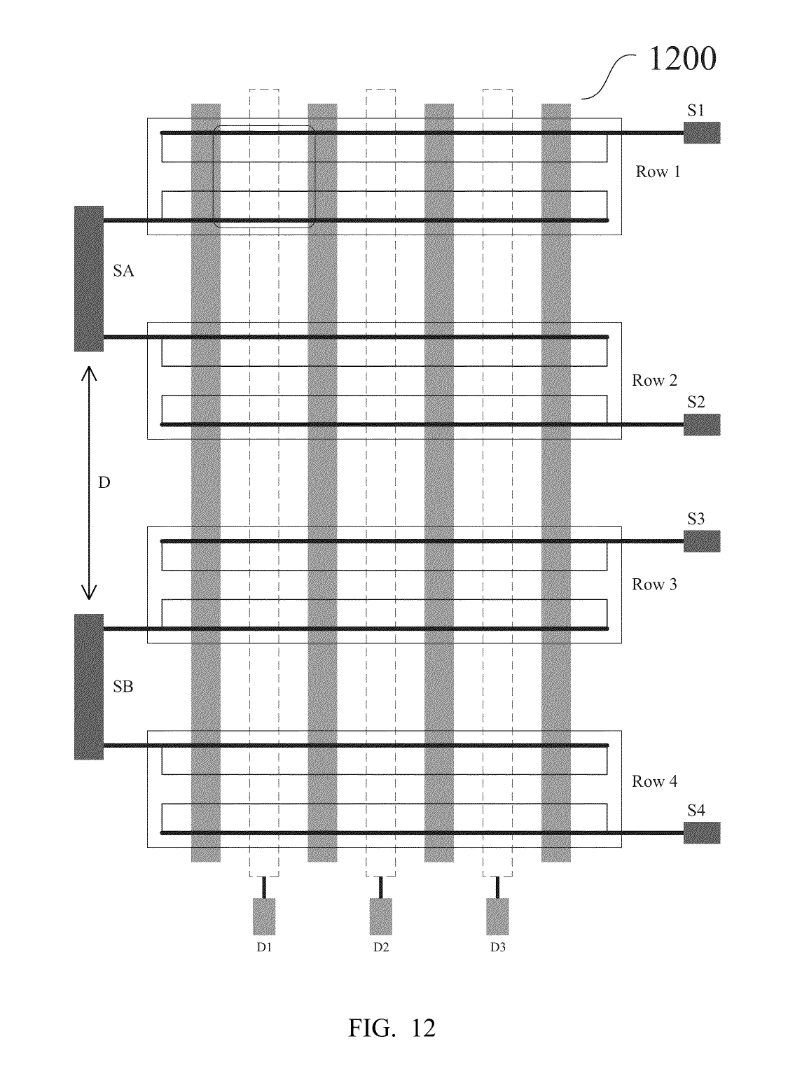

FIG. 8 provides a block diagram for the second embodiment of the invention. PDP 800 comprises an illumination device 805 substantially driven by a sustain driver 810 comprising a multi-phase resonant sustain pulse circuit 815 having outputs SA and SB wherein SA and SB are driven simultaneously, but opposite of each other. Other features of PDP 800 are equivalent to the first embodiment and have like reference numbers. Thus the equivalent features will only be minimally described. Output SA drives a first plurality of sustain electrodes 801 and output SB drives a second plurality of sustain electrodes 802. Sustain electrodes 801 and 802 are paired with scan electrodes 803 and 804 respectively to form rows of discharge cells. Scan and sustain electrodes may be interdigitated, as shown or may be disposed as in FIGS. 1, 2. FIGS. 12-14 provide other arrangements which will be described later. Scan drivers 822 provide row isolation and row selection during addressing periods wherein wall charges are set in discharge cells (pixels or sub-pixels) according to data representing a display image. Chassis 830 provides mechanical support 832 for panel 805, sustain driver 810, scan drivers 822, scan side driver 820, data drivers, a controller, and a power supply. Dashed reference lines 832 indicate that the mechanical connection to the chassis may, or may not, be the system ground.

The resonant sustain driver 815 drives SA and SB concurrently, but out of phase, the current loop including currents I813, I823 and I824 produce canceling magnetic fields within the PDP and thereby reduce the inductance of PDP 805. During such time, ground currents I814 and I828 are reduced to a differential current I823 minus I824.

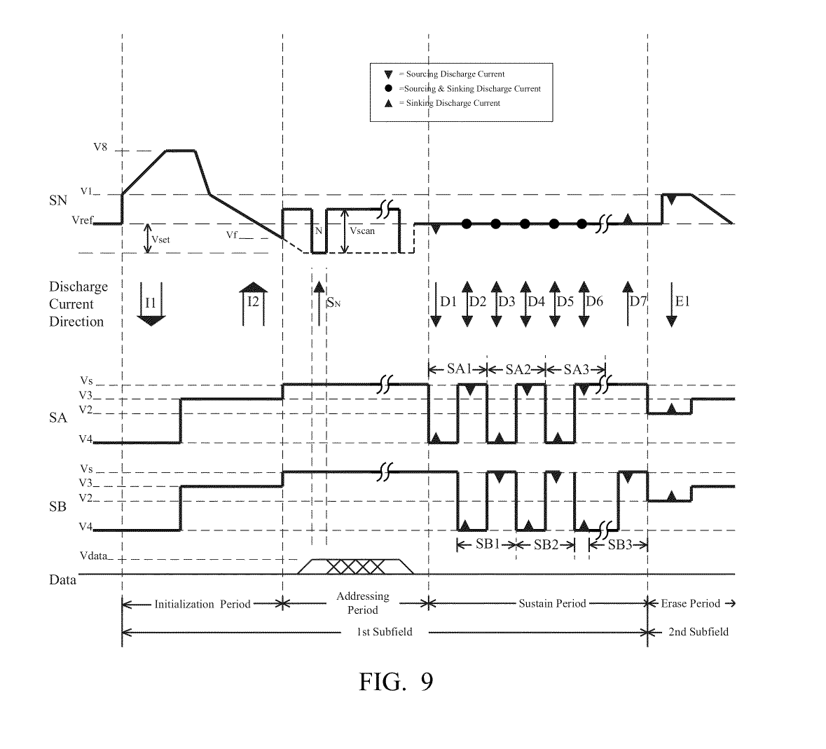

The waveform for driving PDP 800 is shown in FIG. 9. Initialization, addressing and erase periods operate as in the earlier embodiments. During the sustain period, downward pointing triangles indicate the waveform's circuit is sourcing current. An upward pointing triangle indicates the waveform's circuit is sinking current. A filled circle on the Sn waveform indicates a first half of the scan electrodes 803-804 are sourcing current and a second half of the scan electrodes 803-804 are sinking current with their respective sustain electrodes.

During the sustain period, the scan electrodes are biased with a voltage Vref, while sustain pulses are applied to the sustain electrode groups SA and SB. The phase of sustain pulses on SA and SB are 180 degrees out of phase such that the resonant sustain driver can transfer the capacitive energy stored between electrodes SA and SB with respect to their adjacent scan electrodes. To accommodate the phase shift, a first sustain discharge D1 is initiated at each discharge cell along the rows coupled to output SA where an ON state wall charge was previously set. In response to the first falling transition of output SA from Vs to V4, the voltage across discharge cells bearing the provided wall charge will have sufficient voltage for sustain discharge D1 to form. For odd numbered sustain discharges, i.e. D1, D3 and D5, output SA sinks sustain discharge current ISA (shown in FIG. 8). The current ISA, for sustain discharge D1, is the accumulated current drawn by the discharges occurring along the rows coupled to output SA. Consequently, current ISA is sourced from the scan electrodes of rows coupled to output SA. Thus a current I823 is distributed to the discharge cells bearing set wall charge. With only discharge cells coupled to output SA discharging, ground path 840 completes the current loop. Specifically, discharge D1 has a current loop that follows the path where scan drivers 822 are sourcing current I823 from reference voltage Vref, into the scan electrodes with the gas discharge D1 occurring in ON state discharge cells coupled to output Sa. As output SA sinks the current ISA, current I814 returns the current to the reference (scan) side as current I828 flowing through scan side driver 820 with currents I828 and I814 flowing through scan side driver 820.

Having transitioned only the SA electrodes to perform the phase shift, sustain discharges D2, D4 and D6 occur following rising transitions of output SA substantially concurrent with falling transitions of output SB. Discharges are induced in discharge cells along rows coupled to both outputs SA and SB wherein wall charges are set. The current flow of these sustain discharges is such that current ISA is a sourcing current to discharge cells along the rows coupled to output SA and the current ISB is a sinking current for the discharge cells along the rows coupled to output SB. On the reference side, scan drivers 822 coupled to output SA will have a sinking current I823 and a sourcing current I824.

Disparities in the number of discharging cells coupled to output SA and the number of discharging cells coupled to output SB, will effect the net return current flowing through the ground system as I828 and I814. The net return current is nearly zero under the condition where the number of discharging cells coupled to output SA is approximately equal to the number of discharging cells coupled to output SB as I823 equals I824.

The arrangement of rows coupled to output SA and rows coupled to output SB may be interdigitated as in FIG. 8. Neighboring rows can be viewed as single conductors disposed in parallel. Current ISA coupled to I823 and current ISB coupled to I824 can likewise be viewed as single currents having opposite directions. Thus the electrical fields produced by these row currents will cancel inversely proportional to the net return current. Under the condition of equal and opposite row currents, the net return current is zero, and the fields will substantially cancel to minimize the inductance of the rows. Reductions in electrical field strength will reduce the electromagnetic coupling into the surrounding conductors such as the chassis and enclosure. Electromagnetic interference produced by these electrical fields is also reduced.

It may also be noted that the maximum net return current occurs under the condition wherein all the discharge cells coupled to output SA are ON while all of the discharge cells coupled to output SB are OFF. Even under this abnormal condition, the net return current would be one half of that in the prior art.

Nearing then end of the sustain period, discharge D7, restores the phasing shifted by discharge D1 wherein only ON discharge cells coupled to output SA were discharged. Consequently discharge D7 only discharges ON discharge cells coupled to output SB. The current flow for discharge D7 is equivalent to the current flow for discharge D1, only having an opposite direction. Output SB sources current through ON discharge cells of rows coupled to output SB to produce current I824 flowing through the ground system as I828 and I814.

This embodiment is important for reducing electrode inductance, stray circuit inductance and chassis ground currents. That is, for adjacent rows, the current flow of one row is opposite to the current flow of the adjacent row, such that current flowing into one scan driver output can flow out the output of an adjacent scan driver output; further reducing power losses in the scan driver circuitry, since the current flow is substantially eliminated for sustain pulse transitions and reduced by at least half for sustain discharge currents.

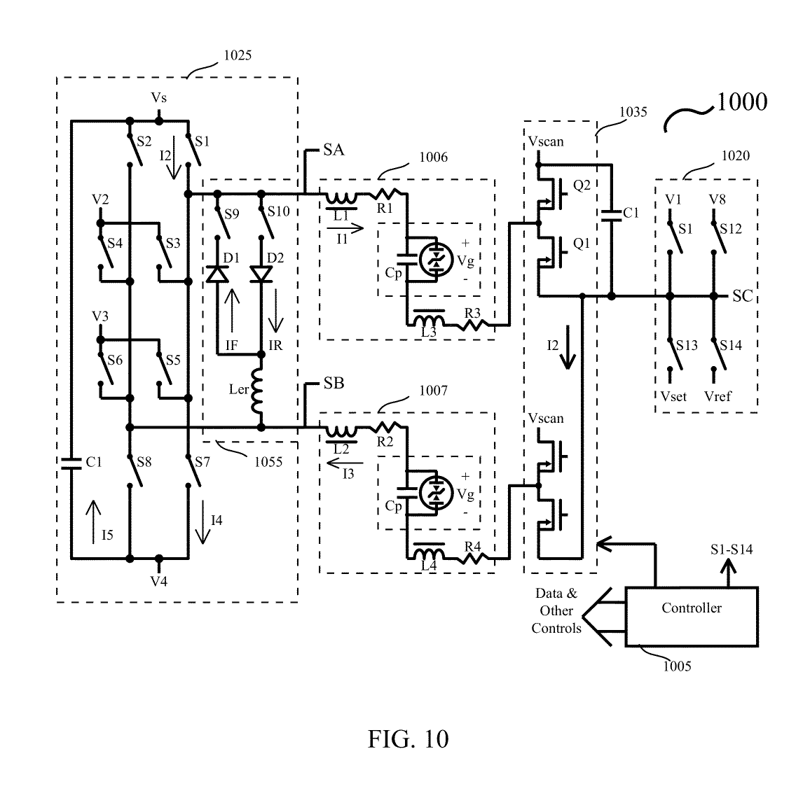

FIG. 10 provides a circuit diagram for the waveform of FIG. 9. A controller 1005 provides controls the timing of switches S1-S14. Sustain driver 1025 provides all sustain functionality, including a single resonant switching circuit 1055. Specifically, switches S1, S3, S5 and S7 drive sustain output SA with voltages Vs, V2, V3 and V4, when closed respectively. Likewise, switches S2, S4, S6 and S8 drive sustain output SB with voltages Vs, V2, V3 and V4 when closed respectively. Resonant switching circuit 1055 transfers the energy from capacitance CP of row 1025 to capacitance CP of row 1045 when S9 is closed, and transfers energy from capacitance CP of row 1045 to capacitance CP of row 1025 when S10 is closed.

For display applications, controller 1005 synchronizes the video input signal with the display, provides gamma correction, subfield ordering and other signal processing functionalities and synchronizes the timing between scan driver circuits 1020 and data drivers (not shown). Scan drivers 1035 provides individual row selection circuits to select rows of pixels 1045 and 1025 independently for addressing. Row selection circuits are driven with a voltage Vscan capacitively coupled to scan circuit 1020 so that the scan driver can float on the on the output SC of scan circuit 1020. Scan circuit 1020 provides rising ramp, falling ramp and sustain bias voltages through switches S6-S14. Scan driver 1035 outputs connect to each scan electrode exemplified by electrode structures 1045 and 1025.

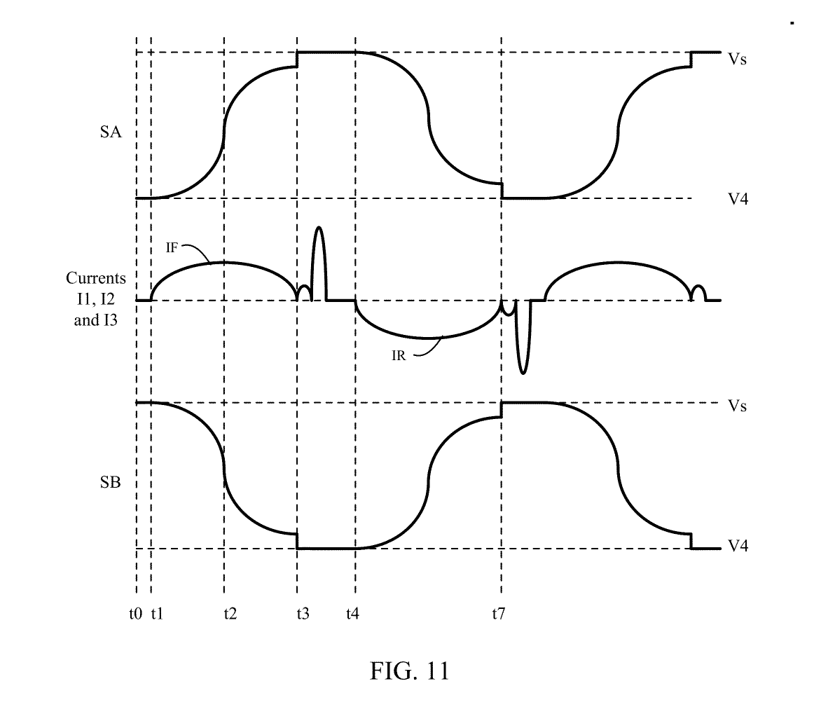

The operation sustain driver 1025 will now be discussed referring to the waveforms of FIG. 11. As shown in FIG. 11, prior to time t0, switch S2 and S7 were closed so that SB is at sustain voltage Vs and SA is at a low voltage V4. Although not shown in FIG. 11, scan driver 1020 has switch S14 closed biasing output SC with the reference voltage Vref. All other switches are open. Scan drivers 1035 have their lower transistors Q1 ON so all the scan electrodes are coupled to output SC. At time t1, Switches S2 and S7 open and switch S9 closes. The voltage difference of Vs on output SB minus voltage V4 on output SA, is applied across resonant inductor Ler. Current pulse IF increases to a peak at time t2, when the voltage on output SA equals the voltage on output SB.

Between times t2 and t3, current pulse IF continues to flow. As the voltage on output SA increases above the voltage on output SB, the current decreases to zero at time t3 as output SA approaches Voltage Vs and output SB approaches voltage V4. At time t3, switches 51 and S8 close, coupling output SA to supply Vs and output SB to supply V4.

The loop for current pulse IF, and later current pulse IR is I1=I2=I3. Since the row current I1 is parallel to row current I3, the magnetic fields of currents I1 and I3 cancel. Note that the current flow I2 is maintained within the scan driver 1035. That is I2 is equal to current flow I1 flowing into scan driver 1035 and current I3 flowing out of scan driver 1035. The net current flow, I2=I1−I3 is zero and so, no current flows through the scan driver's return node SC. Sustain transition current flow is substantially maintained within the illumination device 805 and Sustain transition current flow through a chassis 830 is substantially prevented.

Any discharge cells previously addressed, containing a set wall charge, will initiate a gas discharge and with currents I1 and I3 flowing through electrode structures 1045 and 1025 respectively. The difference in electrode currents I1 and I3 are sourced or sinked by switch S14 of scan circuit 1020. In a fully lit display, with all subpixels ON, electrode current I1 will be substantially equal to electrode current I3, making the current to/from output SC and through the chassis substantially zero. Under the condition where more pixels are discharged through SA than SB, scan bias voltage Vref will source or sink the difference, i.e. current I828 of FIG. 8. In a worst case scenario, switch S14 will source or sink the current for approximately half of the discharge cells. It is preferred to connect voltage Vref to ground.

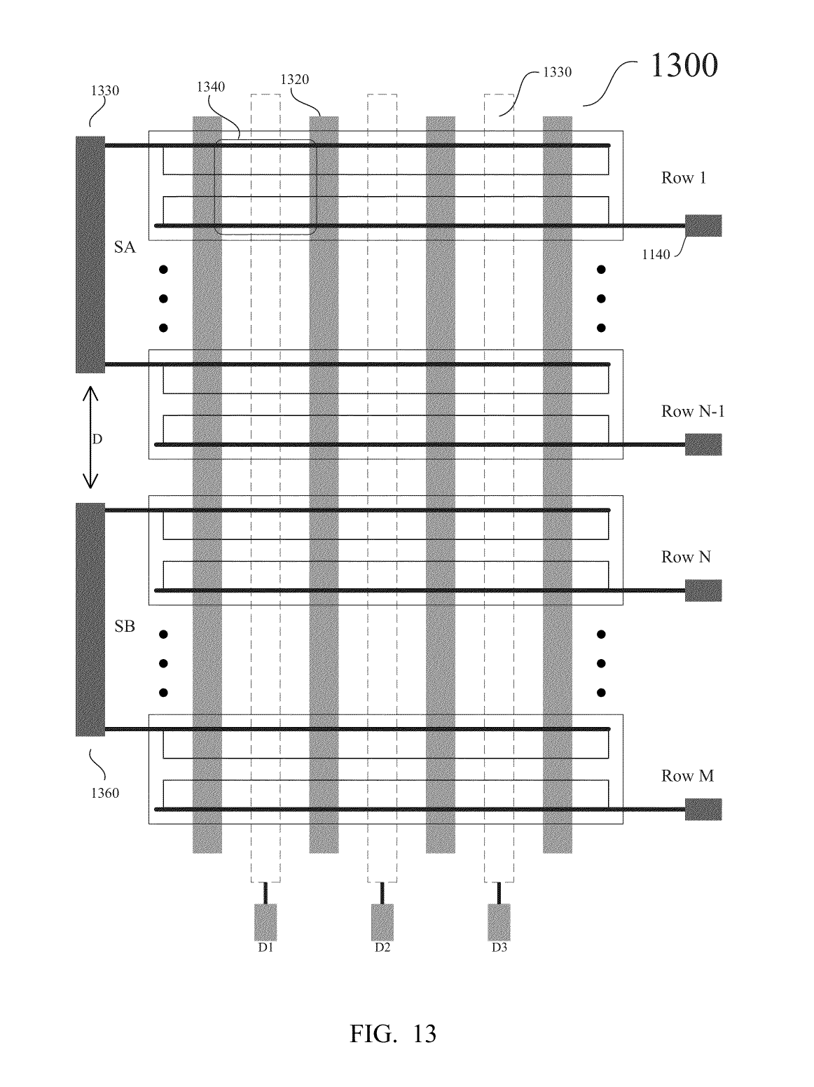

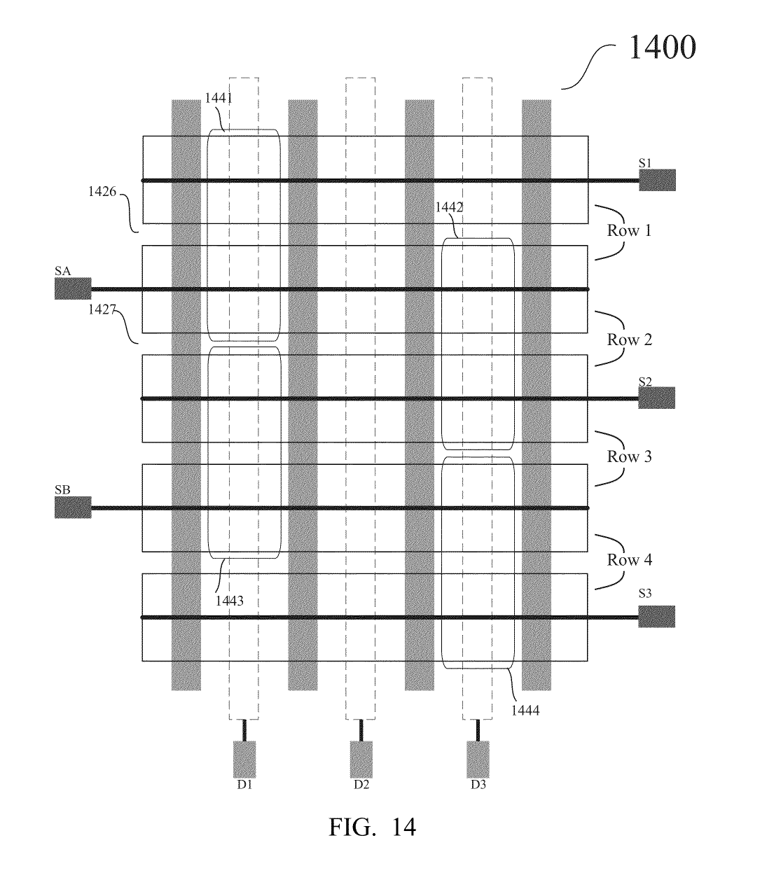

This embodiment of the invention may be applied to a variety of surface discharge electrode configurations as shown in FIGS. 12, 13 and 14. The embodiment is not limited to surface discharge topologies and may easily be applied to other electrode configurations. FIG. 12 illustrates a PDP 1200 where sustain terminals SA and SB, separated by a distance D, each drive two neighboring sustain electrodes driving two rows of discharge cells. FIG. 13 provides another electrode configuration wherein pluralities of sustain electrodes SA and SB, and therefore a plurality of rows, are driven by sustain circuits SA and SB. Such a configuration maintains the features of the invention while allowing the distance D, separating sustain terminals SA and SB, to be increased for improving voltage isolation between terminals SA and SB. FIG. 14 applies the invention to the ALiS driving method's electrode configuration wherein sustain electrodes SA and SB are each adjacent to a pair of scan electrodes. Under the ALiS driving method, interlaced operation drives even rows during a first field period, and odd rows during a second field period. Thus during the odd row field, sustain electrodes SA and SB drive subpixels 1441 and 1443 respectively, while during an even row field, sustain electrodes SA and SB drive subpixels 1442 and 1444 respectively.

In a large area illumination device or PDP, it is preferred to have sustain driver 810 comprise a plurality of resonant sustain circuits 815 to drive a plurality of illumination areas. Such a plurality of resonant circuits may be distributed along one or more axis of the device to position the driver circuits close to the illumination area for further inductance reduction

It should be noted that these embodiments may easily be applied to other common discharge technologies such as opposed discharge, tubular, spherical, multi-electrode and other illumination and display technologies.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A device comprising,
an illumination device,
a first circuit coupled to a first electrode,
a second circuit coupled a second electrode and
a first dischargeable area coupled to said first and second electrodes,
said first circuit periodically applying and inducing alternating first pulsed currents flowing through at least a portion of said first dischargeable area and said second electrode.

2. The device of claim 1, further comprising;
a third electrode coupled to said first circuit,
a fourth electrode coupled to said second circuit and
a second dischargeable area coupled between said third and fourth electrodes,
said first circuit periodically applying and inducing alternating second pulsed currents, flowing through at least a portion of said second dischargeable area and said fourth electrode,
wherein said second pulse currents are of a polarity opposite to said first pulse currents and.

3. The device of claim 2, further comprising a current path between said second and fourth electrodes wherein said first and second pulsed currents are coupled.

4. The device of claim 3, further comprising a non-conductive support structure for mounting said first circuit, said second circuit and said illumination device.

5. The device of claim 1, wherein said applying and inducing alternating first pulsed currents comprises the steps of; applying a first discharge voltage, inducing a first discharge current pulse, applying a second discharge voltage and inducing a second discharge current pulse.

6. The device of claim 5, said first circuit further comprises a resonant pulse driver circuit, periodically applying said first and second discharge voltages to induce said first and second discharge current pulses immediately following the applications of said first and second discharge voltage.

7. The device of claim 1, wherein said second electrode is one of a plurality of scan electrodes coupled to rows of dischargeable areas comprising a plurality of discharge cells, wherein said dischargeable areas are selected during an addressing period, and wall charges are provided in discharge cells according to display data, and wherein said alternating pulsed currents are induced in said discharge cells wherein said wall charges were provided.

8. A device comprising;
a driving circuit for inducing gas discharges in illumination areas in the vicinity of first and second electrodes, wherein during an illumination time period, said illumination areas are discharged by applying a plurality of sustain pulses to said second electrode while said first electrode is biased with a reference voltage.

9. The device of claim 8, wherein said gas discharge device is one of a surface discharge type plasma display, an opposed discharge type plasma display and a dielectric barrier discharge lamp.

10. A method comprising,
applying a first voltage to first and second discharge cells,
applying a first pulse to said first discharge cell
and applying a second pulse to said second discharge cell,
wherein said first voltage sources a first gas discharge current to said first discharge cell and sinks a second gas discharge current from said second discharge cell in response to each said application of said first and said second pulses.

11. The method of claim 10, wherein said first voltage maintains a substantially constant voltage during the application of said pulses.

12. The method of claim 10, wherein first and second pulses are substantially 180 degrees out of phase.

13. The method of claim 12, further comprising transferring charge between said first and second pluralities of discharge cells during transitions of said pulses.

14. The method of claim 10, wherein said first voltage is a reference voltage substantially maintained during the application of said pulses.

15. The method of claim 3, wherein the voltage of said reference voltage is ground.

16. The method of claim 10, wherein said first voltage is applied to a first electrode of said first and second discharge cells and said first pulse is applied to a second electrode of said first discharge cell.

17. The method of claim 10, wherein said first and second pulses are the same pulse and said first and second discharge cells are the same discharge cell.

18. The method of claim 10, wherein said first discharge cell is one of a plurality of discharge cells coupled to a first row of discharge cells, said method further comprising,
selecting a row during an addressing period,
providing wall charges in said plurality of discharge cells according to display data
applying said pulses to said dischargeable area to induce said gas discharge currents in said discharge cells wherein said wall charges were provided.

19. The method of claim 10, wherein said second discharge cell is one of a plurality of discharge cells coupled to a second row of discharge cells

20-38. (canceled)
